(19) United States
(12) Patent Application Publication
(10) Pub. No.: US 2021/0219555 A1
(43) Pub. Date: Jul. 22, 2021

(54) COMPOSITION BASED ON TANNINS AND SAPONINS FOR CONTROLLING PLANT PARASITIC NEMATODES

(71) Applicants: AGROCUBE S.A., Ciudad de Buenos Aires (AR); SILVACHIMICA S.R.L., Cuneo (IT)

(72) Inventors: Andrea Benso, Mondovi (IT); Lorenzo Battaglia, Ciudad de Buenos Aires (AR); Jorge Diz, Ciudad de Buenos Aires (AR)

(73) Assignees: AGROCUBE S.A., Ciudad de Buenos Aires (AR); SILVACHIMICA S.R.L., Cuneo (IT)

(21) Appl. No.: 16/748,873

(22) Filed: Jan. 22, 2020

(51) Int. Cl. A01N 65/08; A01N 65/20

(52) U.S. Cl. CPC A01N 65/08; A01N 65/20

(57) ABSTRACT

A composition for controlling a parasitic activity on a plant, the composition including: a mixture of tannins including: hydrolysable tannins extracted from a chestnut plant or a tara plant and condensed tannins extracted from a mimosa plant or a quebracho plant; and alkaline extract of saponins.

### FIELD OF THE INVENTION

The present invention relates to a composition for the control of plant parasitic nematodes and diseases and to the method of application of the composition to the plants.

### BACKGROUND OF THE PRIOR ART

Plant Nematodes are pests able to infest a large variety of plants species, particularly at root level. Nematode infection might produce root galls, cists, or lesions that limit plant ability to absorb water and nutrients and seriously affects plant's growth and yield potential and quality.

The chemicals traditionally used for controlling nematodes (Methyl Bromide, Phosphors, Carbamates) are very toxic to human beings and the environment.

The prior art is showing new alternatives of synthetic origin for controlling nematodes in plants. These new alternatives have a good toxicological profile and low environmental impact, but unfortunately, they are costly, limited, and subjected to resistance issues.

There is a need for the development of a new composition for controlling plant parasitic with low toxicological and ecotoxicological risk, of a natural origin, and that permits a sustainable growth of the plant.

There are also several root diseases (e.g. Fusarium, Rhizoctonia that might affect plant in association or not with nematodes presence.

### SUMMARY OF THE INVENTION

The present invention relates to a composition for controlling parasitic activity on a plant, the composition including: a mixture of tannins including: hydrolysable tannins extracted from a chestnut plant or a tara plant and condensed tannins extracted from a mimosa plant or a quebracho plant; and extract of quinoa saponins.

### DETAILED DESCRIPTION OF THE INVENTION

The present invention relates to a composition for control of plant parasitic nematodes and diseases. The composition includes:

a mixture including: hydrolysable tannins extracted from a chestnut plant or a tara plant and condensed tannins extracted from a mimosa plant or a quebracho plant; and extract of quinoa saponins.

The present invention uses a currently existing mixture of hydrolysable and condensed tannins that is available in a 50:50 relation at concentrations ranging between 35 and 44% in water. The extracted quinoa saponins is added in volumes that are among 5 to 25% of the tannin volumes considering the addition of antifoaming agents to reduce foam formation.

Altering the order of adding the ingredients is important to prevent excessive foam formation and unstable formulations.

The composition of the present invention is applied to seeds, bulbs, tubers, planting furrow or irrigation system in order to protect plant roots. This allows the composition to immediately act on the nematodes present at the roots, which causes a considerable increase in the yield of the growth of fruits, berries, seeds, roots, tubers, flowers and green parts to be achieved.

An important aspect of the present invention is that the composition is able to have a nematicidal and disease control effect due to the synergistic effect produced by the presence of the mixture of tannins and the saponins present in the extracts. When used separately, the saponin and the tannins extracts do not exhibit important nematicidal effects. Only using both extracts together results in a nematicidal effect at economically feasible dosages.

### Mixture of Tannins

Tannins are a polyphenolic biomolecules that bind to and precipitate proteins. The tannins act as bio-stimulating elements for the plants, as they contain substances which, when applied to the plants or the rhizosphere, stimulate the natural processes, improve the absorption of nutrients, increase the tolerance of plants against biotic and abiotic stresses, and improve the quality of the crop, regardless of the amount of other nutrients used.

Currently tannins are classified by their structural characteristics, in two classes:

A) Hydrolysable tannins, that in presence of hot strong acids are hydrolysed as a monosaccharide like glucose and elagic (elagitannins) or galic (galotannins) acids that are bound with the monosaccharide through ester links.

Galotannins are extracted from galls (Quercus infectoria and Rhus semisalata) and fruits of Sumac (Rhus coriaria) and Tara (Caesalpinia spinosa).

Elagitannins that are called this way because during hydrolysis they generates a lactone form of the hexahydroxyphenyl acid (ellagic acid) and are present in Oak wood (Quercus robur, Quercus petrae and Quercus albus), Chestnut (Castanea sativa) and Mirabolan (Terminalia chebula)

B) Condensed or flavanic tannins (proanthocyanidins) are not easily hidrolised and doesn't has sugars in their structure that are based in a flavan-3-oils (catechin, 5 deoxiflavan-3-oils (as fisetinidol and robinetinidol), leucoanthocyanidins (flavan-4-oli and flavan-3-4-diols) and peltoginoids which are also referred to as proanthocyanidins. The monomeric units bind together to form dimers, oligomers and polymers through C4-C8 or C4-C6 bonds. They are grouped as Proantocyanidins and Profisetinidines.

Proanthocyanidins are naturally present in grapes (Vitis vinifera) seeds and peel and composed by flavonoid molecules that under acid hydrolisis liberate antocianins and other compounds.

Profisetinidinas are extracted from Quebracho wood (Schinopsis balansae Eng. and Schinopsis lorentzii (Griseb) Engler) and mimosa (Acacia meamsii).

The preparation of condensed tannins of mimosa and quebracho (the most preferred tannins for use herein) extracts is a well-established industrial practice and they are commercially available.

If desired, the condensed tannins may be prepared from the bark of Black Wattle (Acacia mearnsii) trees or Quebracho (Schinopsis balansae) wood. Bark or wood, according the species is then chipped and extracted under controlled industrial conditions to obtain the optimum amount of tannin. At the factories, chopped bark or wood is processed, using a counter current principle, in autoclaves under pressure at temperatures above 100 degrees Celsius in order to extract the tannins. The liquid extract so obtained is then concentrated and the hot viscous concentrated liquid is spray dried as powder and the powder placed into bags, which are stitched closed and carefully stacked.

Hydrolisable tannins are mainly extracted from Chestnut wood (Castanea sativa Mill.) that should be harvested in compliance with the public norms foreseen and coming from sustainable and certified management (ISO 22000, ISO 9001, and GMP+), chopped into chips and infused with hot water in autoclaves for a specified time.

The “broths” thus obtained are separated by sedimentation from the exhausted wood, to eliminate impurities that are not soluble in water and then concentrated to obtain a molasse and turned into powder through a drying process by means of spray-drying.

The thus obtained chestnut are then mixed to be sold in powder or in a micro-granular formulation.

The mixture of tannins used in the composition of the present invention include both a condensed and a hydrolysable tannin.

The mixture of tannins may have a concentration of the hydrolysable tannins from about 5 wt % to about 25 wt % and conversely about 5 wt % to about 25 wt % of the condensed tannin, based on the combined weight of both tannins. We focused in balanced mixture of hydrolysable and condensed tannins with a concentration of the hydrolysable tannins from about 15 wt % to about 22 wt % and conversely about 15 wt % to about 22 wt % of the condensed tannin based on the combined weight of both tannins.

The condensed and hydrolysable tannins are mixed in such proportions as they are exploiting the actions of each type of tannin in the rhizosphere environment and directly on the phytoparasitic diseases and nematodes. Tests carried out in the greenhouse with pure tannins in relation to the mixtures have confirmed that the mixture has a higher action than that of the individual tannins.

It was observed that higher concentrations of hydrolizable tannins showed higher biostimulant and fungicidal activity meanwhile higher concentration of condensed tannins improved nematicide effect. Therefore, different combinations of both tannins bring higher efficacy in one or other way, but there are complementary actions among both type of tannins and we confirmed that quinoa saponin addition improved in any case efficacy of tannin mixtures. We need to further evaluate the influence of changing tannin concentrations in the mixtures in combination with saponins.

### Saponins

Quinoa saponines are triterpenic aglicons. There are four main aglicos structures present in quinoa seeds, that respond to the following structure:

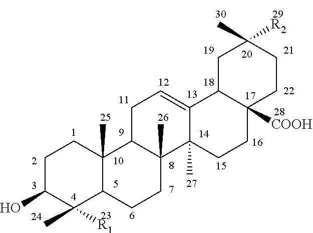

| Aglicone | R 1 | R2 |
|---|---|---|
| Oleanolic acid | CH₃ | CH₃ |
| Hederagenin | CH₂OH | CH₃ |
| Phytolacagenic acid | CH₂OH | COOC H₃ |
| Serjanic acid (30-O- | CH₃ | COOC H₃ |
| methylspergulagenate) | | |

Main carbohydrates associated with the structure are glucose, arabinose and galactose. Woldemichael & Wink, (2001), determined the following saponines from quinoa seeds purified by HPLC by FAB MS (Fast Atom Bombarment Mass Spectrometry)

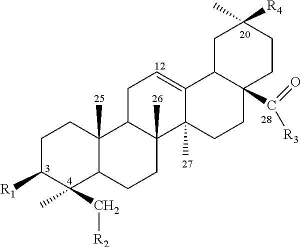

### 1 R1=GlcA R2=H R3=Glc R4=CH3

### 1a R1-GlcA R2=H R3-H R4=CH3

### 2 R1-Ara R2=OH R3=Glc R4=CH3

### 2a R1=Ara R2=OH R3=H R4=CH3

### 3 R1=Ara(3□1)Glc R2=OH R3=Glc R4=CH3

### 3a R1-Ara(3□1)Glc R2-OH R3=H R4=CH3

### 4 R1-Ara R2=OH R3=Glc R4=COOCH3

### 4a R1=Ara R2=OH R3=H R4=COOH

### 5 R1=Ara(3□1)Glc R2=OH R3=H R4=COOCH3

### 6 R1=Ara(3□1)Glc R2=OH R3-Glc R4-COOCH3

1: 3-O-D-ádcido glucopiranosil oleanólico-28-O-D-glucopiranosil éster
2: 3-O-L-arabinopiranosil hederagenina-28-O-D-glucopiranosil éster
3: 3-O-D-ácido glucopiranosil-(1□3)-L-arabinopiranosil hederagenina-28-O-D-glucopiranosil éster
4: 3-O-L-ácido arabinopiranosil fitolacagénico-28-O-D-glucopiranosil éster
5: 3-O-D-ácido glucopiranosil-(1□3)-O-L-ácido arabinopiranosil fitolacagénico
6: 3-O-D-ácido glucopiranosil-(1□3)-O-L-ácido arabinopiranosil fitolacagénico-28-O-D-glucopiranosil éster

According with Kuljanabhagavad et al., (2008), four most important saponines in Quinoa are the following:

1: Aglicone: Phytolacagénic acid, substituted in C-3 by R-D-Glc (1□3)-α-LAra, —Chemical formula: C48H76O20

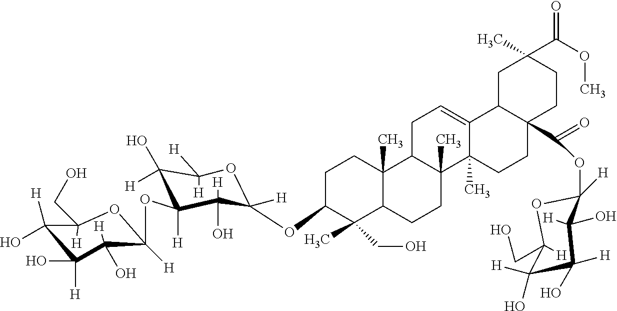

2: Aglicone: Phytolacagénic acid, substituted in C-3 by: α-LAra Chemical formula: C₄₂H₆₆O₁₅

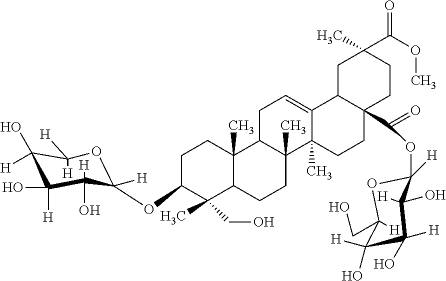

3: Aglicone: hederagenin with a sustituent in C3: β-D-Glc (1-3)-α-L-Ara. Chemical formula: C₄₇H₇₆O₁₈

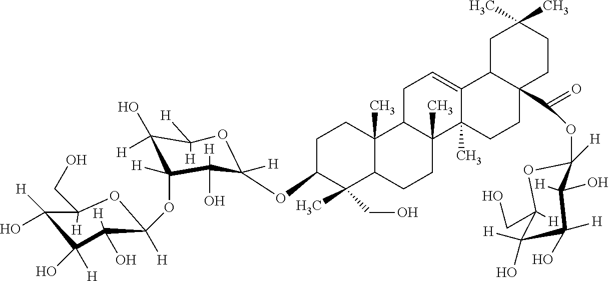

4: Aglicone: Oleanolic acid with a sustituent in C3: β-DGlcA. Chemical Formula: C₄₂H₆₆O₁₄

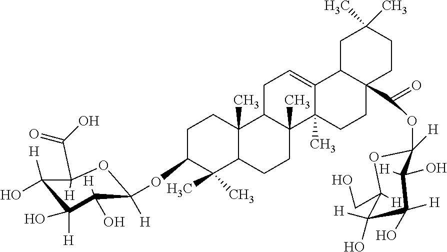

In all cases sapogenines has in Carbon 28 a molecule of glucopyranose.

Saponins are natural surfactants capable of permeating the walls of plants and microorganisms due to their association with the sterols present in cell membranes. Their chemical structure consists of a hydrophobic core (aglycone) to which are bonded sugar chains of a hydrophilic nature.

The biological and chemical activities of the saponins are directly related to the number of sugar chains bound to the sapogenin. Saponins with sapogenins that have two sugar chains are called bi-desmosidic saponins; those that have one sugar chain attached to the sapogenin are called mono-desmosidic saponins. Generally mono-desmosidic saponins show fungal activity, while bi-desmosidic have good tenso-active properties and produce abundant foam.

The composition of the present invention utilizes quinoa saponins, which are extracted from quinoa seeds. Quinoa saponins are mainly bi-desmosidic, with sugar chains attached at C-3 and C-28. They concentrate in the outer husk of the grain.

Quinoa saponins are extracted by several methods. Traditional process includes soaking the seeds in alkaline solutions, that has very low efficacy and water residues are very contaminant. By this reason in the present invention it was chosen to extract saponins from seed dust that was obtained with an experimental mill by grinding 1 kg of seed and uniformizing the dust with a 120 micron mesh and then extract the saponines using alcoholic extraction under microwave treatment that we found as a more effective extraction method.

Anyway, we consider that other extraction methods, despite less efficient won't significantly change the quality and biological activity of the extracted saponines. Next table show differences among extraction methods (Giana, 2013).

| | | | Solvent | Extraction |
|---|---|---|---|---|
| Extraction | Timing | | demand | efficacy |
| method | (minutes) | Solvent | (ml/g) | (%) |
| Shaking | 720 | Ethanol 95% | 40 | 2.58 |
| Ultrasonic | 30 | Ethanol 95% | 60 | 1.72 |
| Reflux | 120 | Ethanol 95% | 40 | 2.22 |
| Supercritical | 180 | Ethanol 95% + | — | 1.52 |
| fluid | | CO2 | | |
| Microwave assisted | 5 | Ethanol 95% | 25 | 5.11 |

The quinoa saponins are added to the composition of the present invention; thus, their addition can improve the dispersion and penetration of tannins polyphenols, improving their nematicide and fungicide action. It is estimated that this effect can be extended to saponins from other origins and the intention of the patent is to give it extension over all these alternatives.

The composition may be applied directly to seeds, seedlings, shoots, roots, and/or foliage of the plant to be protected. The composition may also be applied directly to seeds, seedlings, shoots, tubers, bulbs, surrounding soil, irrigation water, roots, and/or foliage of a plant that is infected with a disease, thereby treating the disease.

An antifoaming agent Polypropylene glycol 0.1% was added to the composition.

As the samples showed a reasonable stability, it was not considering the addition of any other compound, but when thinking in commercial formulations, in order to keep stability under different pH conditions and cation presence, it was necessary to add EDTA Na 3.5% in the formulation.

### Examples

The studies were carried out by evaluating the effects of the composition of the present invention on the plant development and damage reduction of Meloidogyne incognita in soybean plants as described below:

### 1. Formulation Process:

a. Tannin Combination

The tannin mixture was obtained by combining commercial products Agritan BT that combines Quebracho and Chestnut tannins at concentrations of 17.5 and 17.5%.

b. Saonins:

Quinoa saponines were extracted directly from seed with ethanol extract in microwave oven.

Extraction followed the following process:

1 kg of Quinoa seed was grinding in an experimental mill and the flour was uniformized with a 120-micron mesh

2 g of Quinoa seed dust are placed in a 50 ml Schott Duran glass with 10 ml ethanol.

The glass with the seeds and ethanol was cooked in a 900 MW microwave oven during 5 minutes.

After cooling with water, the extract was separated from seeds by filtration through a 0.2 micron pores Milipore membrane filter

The operation was repeated 20 times with new samples in order to obtain a volume of approximately 200 ml extract.

Saponin content was measured by absorbance at 528 nm in a Perkim Elmer spectrophotometer Lambda 35 using Libermann-Burchard reactive that consist in a mixture of concentrated sulphuric acid with acetic anhydride in relation 5:1 that is diluted in the extract at a concentration of 22.23% in order to react with the saponines and colour the sample.

The solution had 4.56% saponin concentration and the volume was reduced by heating in low pressure chamber until reducing alcohol solution in 75% and generating approximately 50 ml of 18% concentration formulation.

### Experimental Formulations.

Saponins were diluted in Tannins mixture and saponins were combined in order to evaluate the effects in seed treatment. In order to reduce foam formation, all treatments were added with 0.1% Polypropylene glycol. 10 cc of each one of the following ratios was prepared:

| Tannins mixture/ | Total | Tannins mixture | Saponin |
|---|---|---|---|
| saponin ratio | volume | extract (cc) | extract (cc) |
| 1:0 | 10 | 10 | 0 |
| 8:1 | 10 | 9 | 1 |
| 4:1 | 10 | 8 | 2 |
| 2:1 | 10 | 6.5 | 3.5 |
| 0:1 | 10 | 0 | 10 |

Each formulation was used to treat soybean seeds at three different rates in soybean (250, 500 and 750 cc/100 kg seed), as detailed in the following table:

| | Dose | Rate in | Tannin extract | Saponin extract |
|---|---|---|---|---|
| Tannins mixture/ | (cc/100 | 100 g | (cc/100 | (cc/100 |
| saponin ratio | kg seed) | seed (cc) | g seed) | g seed) |
| 1:0 | 250 | 0.25 | 0.25 | 0 |
| 1:0 | 500 | 0.5 | 0.5 | 0 |
| 1:0 | 750 | 0.75 | 0.75 | 0 |
| 8:1 | 250 | 0.25 | 0.222 | 0.028 |
| 8:1 | 500 | 0.5 | 0.444 | 0.056 |
| 8:1 | 750 | 0.75 | 0.666 | 0.084 |
| 4:1 | 250 | 0.25 | 0.2 | 0.050 |
| 4:1 | 500 | 0.5 | 0.4 | 0.1 |
| 4:1 | 750 | 0.75 | 0.6 | 0.15 |
| 2:1 | 250 | 0.25 | 0.17 | 0.083 |
| 2:1 | 500 | 0.5 | 0.33 | 0.17 |
| 2:1 | 750 | 0.75 | 0.5 | 0.25 |
| 0:1 | 250 | 0.25 | 0 | 0.25 |
| 0:1 | 500 | 0.5 | 0 | 0.5 |
| 0:1 | 750 | 0.75 | 0 | 0.75 |

The seed were treated by putting 100 g seed in ajar and adding the volume corresponding to each treatment with a 1 ml syringe and stirring until the product is distributed homogeneously in the seed surface.

3 seeds of each treatment were planted in individual pots filled with Meloidogyne infected soil. Each treatment is replicated in 6 pots. When plants reached V2 stage it was selected a single plant per pot and when plants arrived to R3 stage, they were taken out and nematode gall number was evaluated.

Table 2 shows the reduction of plant parasitic after the application of the composition according to the present invention:

| Tannins mixture/ | Dose Cc/100 | % gall | Variation |
|---|---|---|---|
| saponin ratio | kg seed | reduction | w/tannins |
| 1:0 | 250 | 57 | |
| 1:0 | 500 | 61 | |
| 1:0 | 750 | 71 | |
| 8:1 | 250 | 53 | −4 |
| 8:1 | 500 | 70 | +9 |
| 8:1 | 750 | 65 | −6 |
| 4:1 | 250 | 65 | +9 |
| 4:1 | 500 | 77 | +16 |
| 4.1 | 750 | 81 | +10 |
| 2:1 | 250 | 59 | +2 |
| 2:1 | 500 | 78 | +17 |
| 2:1 | 750 | 79 | +8 |
| 0:1 | 250 | 59 | |
| 0:1 | 500 | 47 | |
| 0:1 | 750 | 72 | |

It has been found, however, that use of a composition containing a mixture of tannins together with saponins involves a synergistic effect which considerably improves the nematicidal effects on plants, compared to those obtained from application of the individual products.

As can be seen from Table 2, the best results were obtained when the ratio of the mixture of tannins to saponin was between 4:1 to 2:1. The best results were obtained when the ratio Tannins mixture/saponin was 4:1 and the dosage was 750.

However, as a great advantage of the present invention over the previous art, the present inventors were able to establish that when these saponins are applied in combination with a mixture of condensed and hydrolyzed tannins, there occurs a synergistic effect which permits to control nematodes by application of economically feasible dosages of the product.

What is claimed is:

1. A composition for controlling a parasitic activity on a plant, the composition comprising:
a mixture of tannins including: hydrolysable tannins extracted from a chestnut plant or a tara plant and condensed tannins extracted from a mimosa plant or a quebracho plant; and
an extract of saponins.

2. The composition according to claim 1, wherein the extract of saponins is from quinoa saponins.

3. The composition according to claim 1, wherein a ratio of the mixture of tannins to saponin is between 4:1 to 2:1.

4. The composition according to claim 1, wherein a ratio of the mixture of tannins to saponin is 4:1.

5. The composition according to claim 1, wherein the mixture of tannins has a concentration of the hydrolysable tannins from about 20 wt % to about 20 wt % of the condensed tannin, based on the combined weight of both tannins.

6. The composition according to claim 1, wherein the condensed tannins are extracted from a mimosa tree, a quebracho tree, a gambier tree, a pine tree, a spruce tree, a fir tree, a tanoak tree, an oak tree, a birch tree, a maple tree, an eucalyptus tree, a tare tree, a catechu tree, or mixtures thereof.

7. The composition according to claim 1, wherein the condensed tannins are extracted from a mimosa tree or a quebracho tree.

8. The composition according to claim 1, wherein the hydrolysable tannins are extracted from a chestnut tree, a tara tree, or mixture thereof.

9. A method for controlling a parasitic activity on a plant comprising applying to a section of the plant a composition containing a mixture of tannins including: hydrolysable tannins extracted from a chestnut plant or a tara plant and condensed tannins extracted from a mimosa plant or a quebracho plant; and alcoholic extraction of saponins quinoa seeds

10. The method according to claim 9, wherein a ratio of the mixture of tannins to saponin is 4:1.

11. The method according to claim 9, wherein the mixture of tannins has a concentration of the hydrolysable tannins from about 20 wt % to about 20 wt % of the condensed tannin based on the combined weight of both tannins.
